(19) United States
(12) Patent Application Publication
(10) Pub. No.: US 2003/0206311 A1
(43) Pub. Date: Nov. 6, 2003

(54) Method and apparatus for providing a user ID to a printer for printing personalized content

(76) Inventors: Shane Konsella, Star, ID (US); Grady Cooper, Boise, ID (US); Wesley Chan, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/139,697

(22) Filed: May 2, 2002

(51) Int. Cl. G06F 15/00; G06K 1/00

(52) U.S. Cl. 358/1.14; 358/1.15

(57) ABSTRACT

A method and apparatus for providing a user ID to a printer to print personalized content for a specific user. The printer detects an ID provided by a user. This ID uniquely identifies the user. The printer determines a reference to the personalized content. The reference is based upon the user ID. The printer uses the reference to request the personalized content stored somewhere on a network. Upon receipt of the personalized content over the network, the printer prints the personalized content on paper.

### TECHNICAL FIELD

The present invention pertains to a method and apparatus for providing a user identification to a printer for printing personalized content for that user.

### BACKGROUND ART

Applications running on personal computers (PC's) are used to facilitate the creation and access of documents, spreadsheets, images, web pages, and other types of electronic formatted files. Typically, these files are stored on the hard disk drive of the user's PC. Often, a user may desire to print specific content stored in the computer's memory for purposes of ease of perusal, dissemination to others, archiving and record-keeping, etc. This can be accomplished by attaching a printer as a peripheral device to that PC. Next, the PC and printer have to be properly configured in order to enable the PC to printer to that particular printer. FIG. 1 shows a conventional PC 101 coupled to a printer 103. A user inputs data and commands to the PC 101 via keyboard 102. The user can request that a paper hard copy of any of the content stored on PC 101 be printed out on printer 103. The requested data stored on the PC 101 is then transmitted electronically over cable 104 to printer 103. Upon receipt of the data, printer 103 prints the data on paper.

In many cases, a printer is shared amongst several PC's in a network. FIG. 2 shows a typical prior art shared networked printer configuration. Basically, a number of PC's 201-204 are coupled, either directly or wirelessly, to a network 205. Network 205 can be a local area network (LAN), metro area network (MAN), virtual network, or an intranet. PC's coupled to the network 205 can communicate with other PC's, download files, and access the Internet 206. In this manner, all sorts of data and files are made available to the users. One or more printers 207-208 may be coupled to the network 205 in order so that multiple users can more efficiently and economically share these peripheral devices. Often, a more powerful server 209 is coupled to network 205 in order to facilitate the storage, distribution, and handling of data over network 205.

Although the PC/printer combination and networked printer configuration have gained widespread acceptance, there still exist several major drawbacks. One main problem pertains to the fact that PC's and printers are inherently stationary devices. Consequently, users are quite often inconvenienced or even prevented from printing while they are traveling or otherwise away from their office or home.

Whereas several PC manufacturers have made great strides in designing portable “laptop” computers, users must nonetheless lug these laptop computers along with them on their trips and make sure the battery is charged. Once they arrive at their destination, the user must somehow find a printer, figure out the proper printer driver(s), appropriately configure the laptop, and electronically connect the laptop to access that printer. For a networked printer, the user must also somehow gain access privilege to the network before they can even attempt to connect with the printer.

This process requires expert knowledge and technical skill and is quite challenging and burdensome to successfully accomplish. It is quite likely to be beyond the abilities of the average user to hook up his or her PC to a printer. Errors in the process might interfere or otherwise jeopardize printing for other users using or sharing that printer. And even if one knew how to properly hook up the laptop to print, the task is time intensive and requires a much effort and energy to be expended. The problem is exacerbated if the process needed to be repeated for multiple users desiring to print their documents stored on their respective laptop computers.

Therefore, if it is imperative for a document or file to be printed from a remote location, users are often faced with the technologically daunting, labor intensive, and time consuming task of finding and hooking up to a nearby printer. In many cases, this task is beyond the skill of the average user. Furthermore, faced with this overwhelming task, users may just postpone their printing until they arrive back at their usual office, home, or workplace, even though they would have preferred onsite printing. At best, this problem poses a major inconvenience; at worst, it prevents critical documents from being timely printed.

### SUMMARY OF THE INVENTION

A method and apparatus for providing a user ID to a printer to print personalized content for a specific user is disclosed. The printer detects an ID provided by a user. This ID uniquely identifies the user. The printer determines a reference to the personalized content. The reference is based upon the user ID. The printer uses the reference to request the personalized content stored somewhere on the network. Upon receipt of the personalized content over the network, the printer prints the personalized content on paper.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows a conventional personal computer coupled to a printer.

FIG. 2 shows a typical prior art shared networked printer configuration.

FIG. 3 shows a client-server configuration where the printer is the client device in accordance with one embodiment of the present invention.

FIG. 4 shows a networked client printer in accordance with one embodiment of the present invention.

FIG. 5 is a flowchart describing the steps of the process for providing a user identification to a printer for printing personalized content in accordance with one embodiment of the present invention.

FIG. 6 is a detailed diagram of the interfaces, functions, and processes of an apparatus for delivering personalized content on printers using radio frequency auto-ID tags in accordance with one embodiment of the present invention.

FIG. 7 is a flowchart describing in detail, the steps for a method of delivering personalized content on printers using ID's in accordance with one embodiment of the present invention.

FIG. 8A shows how a request by a printer to a content transformation service causes an attendee's ticket to be printed out.

FIG. 8B shows how a request by a printer to a content transformation service results in the attendee's itinerary to be printed out.

FIG. 8C shows how a request by a printer to a content transformation service results in the attendee's map to be printed out.

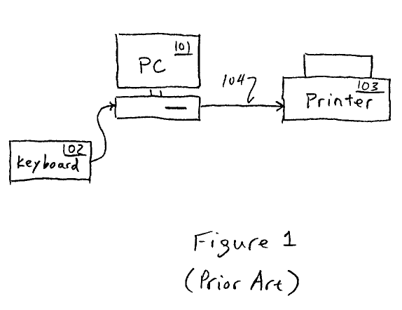

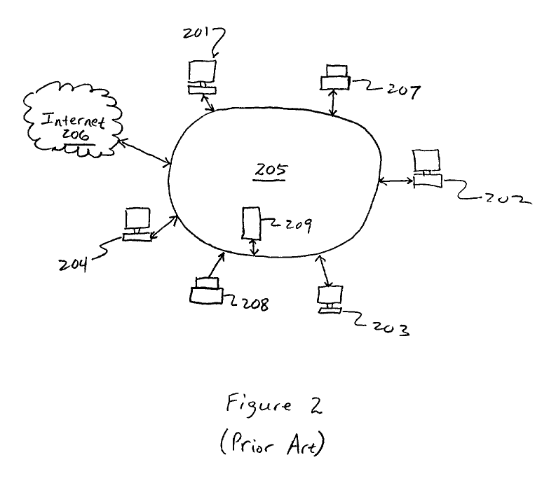

### DETAILED DESCRIPTION OF THE INVENTION

A method and apparatus for providing a user identification to a printer for printing personalized content for that user is described. In the following detailed description of the present invention, numerous specific details are set forth in order to provide a thorough understanding of the present invention. It should be noted that the present invention may be practiced without these specific details or by using alternate elements or methods. In other instances well known methods, procedures, components, and circuits have not been described in detail as not to unnecessarily obscure aspects of the present invention.

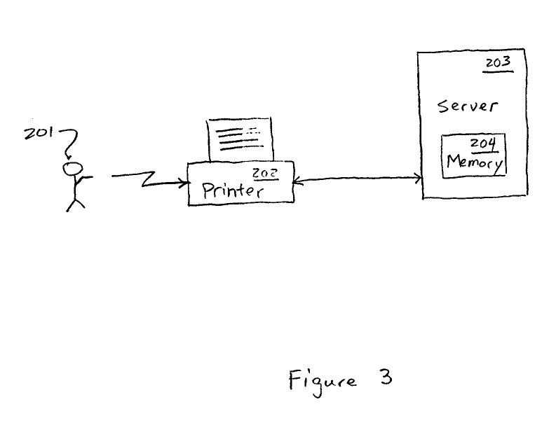

FIG. 3 shows a client-server configuration where the printer is the client device in accordance with one embodiment of the present invention. A user 201 comes in close proximity to a printer 202 and provides the printer 202 with his or her personal identification. The personal identification can be provided by manually entering a Personal Identification Number (PIN), social security number, or a password, which identifies the user 201 to printer 202. The personal identification can also be provided electronically. For example, a badge, card, or some other personal item bearing a bar code, magnetic strip, memory chip, etc. can swiped or temporarily inserted into printer 202. The personal identification can also be provided to printer 202 wirelessly (e.g., infrared, radio frequency transmitter, 802.11, etc.). One convenient and expeditious way to identify the user to printer 202 is by means of biometrics (e.g., fingerprint scan, retina scan, voice recognition, etc.). Once printer 202 recognizes the identity of user 201, it forwards a request to server 203. The personal content corresponding to user 201 is stored in the memory 204 of server 203. In response to the receiving the request from printer 202, server 203 retrieves the personal content corresponding to user 201 and forwards this information to printer 202. Thereupon, printer 202 automatically prints out a paper hardcopy of the user's personal content.

This scheme offers several advantages over the prior art. One major advantage is that the user need not carry a laptop or other portable device. Indeed, there is no need for a laptop, PC, workstation, terminal, PDA, or some other electronic device in order for a user to print. The printer is no longer a peripheral device which requires interaction with a laptop, PC, workstation, terminal, etc. Instead, the printer essentially acts as a client device to the server. The user simply provides an identification to the printer in order to print the desired documents or files. Another huge advantage is that the user is not required to configure any software or have to worry about any hardware issues. This makes it extremely easy, convenient, and cost-effective for users to print their own personalized content.

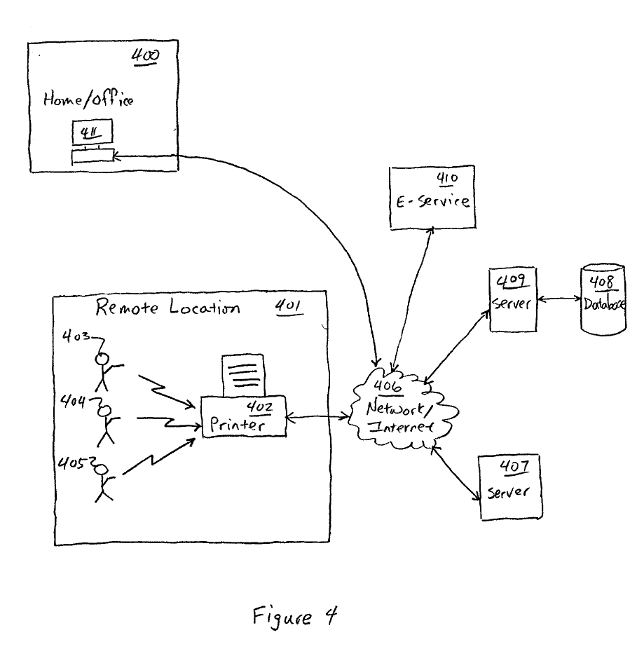

FIG. 4 shows a networked client printer in accordance with one embodiment of the present invention. When users are away from their normal home and/or office environment 400; they may nonetheless print documents and/or files from a remote location 401, provided that the remote location has an installed client printer 402 in accordance with embodiments of the present invention. Multiple users 403-405 can all use the same client printer 402 to print out their respective personalized content. This is accomplished by the users providing their respective identification to client printer 402. Based on the identification, the client printer 402 determines a pointer or some reference to the location of the requested personalized content. The client printer 402 transmits the requests over a network and/or the Internet 406 to the appropriate locations specified by the pointer, address, or reference which contain the requested personalized content.

The personalized content for different users may reside in different locations. For example, the personalized content for user 403 may reside in a server 407 coupled to the network/Internet 406. Alternatively, the personalized content for user 404 may be stored in a database 408 corresponding to server 409. The personalized content may also be provided by an e-service 410 which acts as a gateway to other sites, portals, web pages, e-commerce, and other types of electronic services companies and locations which hosts the personalized content. The personalized content may also stored locally on a computer 411 at the user's normal office or home 400. No matter where the personalized data is ultimately stored, if it can be accessed via the network/Internet 406, it can be printed out on printer 402. The background processing, transmissions, and transactions are all handled transparent to the user. All the user is required to perform is to provide the client printer 402 with an identification. The client printer 402 automatically prints out the correct personalized content belonging to each of the different users.

Several examples are now presented to demonstrate the utility, versatility, and effectiveness offered by the present invention. In one example, the client printer may be set up in a conference room. When registering, conference attendees fill out a form indicating which presentations they wish to attend. Conference attendees are issued RFID (radio frequency identification) badges upon arrival at the conference. When a conference attendee swipes his or her badge over the client printer located at the entrance to the conference hall, his or her personalized schedule is automatically printed. The personalized schedule may include times, locations, and perhaps maps to the meetings or presentations chosen by that particular attendee. Similarly, in another example, conference attendees are issued RFID badges upon arrival at the conference. Dedicated client printers are located at the entrance to the presentation rooms. When a conference attendee swipes his or her badge, the correct presentation(s) are printed out and optionally along with advertisements and/or coupons for other upcoming conferences, presentations, talks, books, etc. which he or she may also be interested in obtaining. In other examples, a client printer may be used to print out personal emails, tickets, receipts, financial papers, news/business reports, official documents, schematics, plans, guides, legal contracts, invoices, human resource files, inventories, notes, address books, journal entries, sales pitches, forecasts, advertising, marketing brochures, slide shows, etc. In fact, various embodiments of the client printer can be used to print out anything from a remote location that could otherwise be conventionally printed.

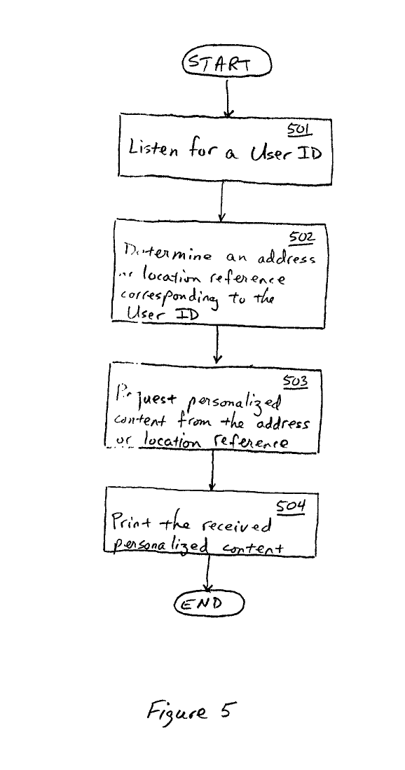

FIG. 5 is a flowchart describing the steps of the process for providing a user identification to a printer for printing personalized content in accordance with one embodiment of the present invention. Initially, the printer listens for a User ID in step 501. When a User ID is detected, the printer determines in step 502, an address or location reference, such as a Uniform Resource Locator (URL), which corresponds to that User ID. The printer sends a request according to the address or URL that points to the personalized content in step 503. Once the personalized content is received by the printer in step 504, it is printed out on paper.

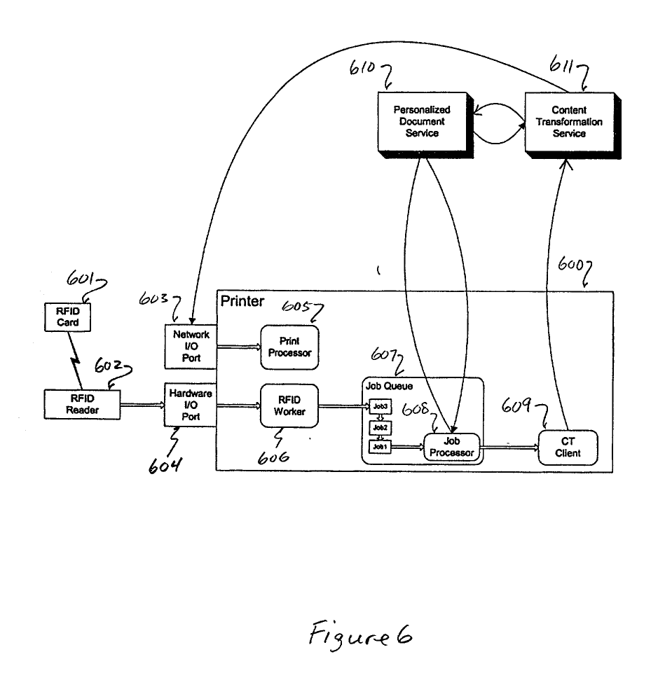

FIG. 6 is a detailed diagram of the interfaces, functions, and processes of an apparatus for delivering personalized content on printers using radio frequency auto-ID tags in accordance with one embodiment of the present invention. Using radio frequency (RF) technology, an identification (ID) is transferred from an RFID card 601 to an RFID reader 602. In one embodiment, the ID is a unique number which identifies the person holding the card. The RFID reader 602 reads the ID and transmits the ID to one of the hardware input/output (I/O) ports 604 of printer 600 to which it is connected. A service (e.g., RFID worker 606) running in the printer and listening for data to arrive through the hardware I/O port 604 receives the ID. In one embodiment, the RFID worker 606 is a piece of software code which constructs a URL. The URL identifies the appropriate personalized document service 610 to use, the printer's context, and the ID. The context specifies the task to which printer 600 is dedicated. The URL is then added as a job to the job queue 607. Job queue 607 temporarily stores all the jobs from various users which have yet to be executed and printed. The job processor 608 removes jobs (e.g., Job1, Job2, Job3, etc.) from the job queue 607 one at a time. For each job, the job processor 608 requests from the personalized document service 610 a list of documents to be printed, given the job's context and ID.

The personalized document service 610 may be a PC, server, or workstation which constructs personalized documents and returns to the job processor 608, a list of URLs to the documents to be printed for the given context and ID. For each document in the list, the job processor 608 passes its URL to a content transformation client 609. The content transformation client 609 formulates and sends a request to the content transformation service 611. The request includes the URL to the document to be printed, the internet protocol (IP) address of the requesting printer, and a port number (e.g., 9100). The content transformation service 611 requests the content of the document identified by the URL. In one embodiment, the document resides on the personalized document service 601. However, it could reside on any web server. The web server hosting the document (e.g., the personalized document service 610) returns the content of the document identified by the URL to the content transformation service 611. The content transformation service 611 transforms the content identified by the URL into printer-consumable data (e.g., Printer Control Language—PCL) and sends it to the printer's network IO port 603 using the IP address and port number supplied by printer 600. The printer's print processor 605 reads the printer-consumable data, which is the same as with any other network print job, and the document is printed on paper.

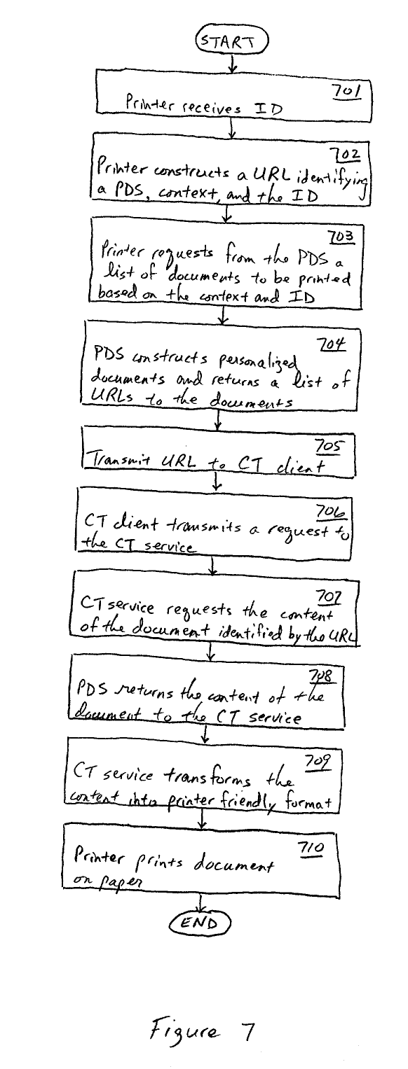

FIG. 7 is a flowchart describing in detail, the steps for a method of delivering personalized content on printers using ID's in accordance with one embodiment of the present invention. The printer sits idle in step 701 and waits for a user to provide it with a user ID. Alternatively, the ID can be provided by a separate external device (e.g., bar code reader, scanner, RF receiver, etc.) coupled to the printer. Once the printer receives an ID, the printer constructs a URL which identifies a personalized document service (PDS), the printer's context, and the ID in step 702. Next, in step 703, the printer requests from the PDS a list of documents to be printed based on the context and the ID. In step 704, the PDS responds by constructing personalized document(s) and returns a list of URLs pointing to those document(s) back to the printer. For each document on the list, the printer passes its URL to a content transformation (CT) client in step 705. In response, the CT client formulates and transmits a request to the CT service in step 706. This request includes the URL to the document to be printed, the IP address of the requesting printer, and a port number. The CT service requests the content of the document identified by the URL in step 707. Thereupon, the PDS returns the content of the document to the CT service in step 708. The CT service then transforms the document into a printer-readable or printer-friendly format (step 709) and transmits this data to the printer which subsequently prints out the document on paper in step 710.

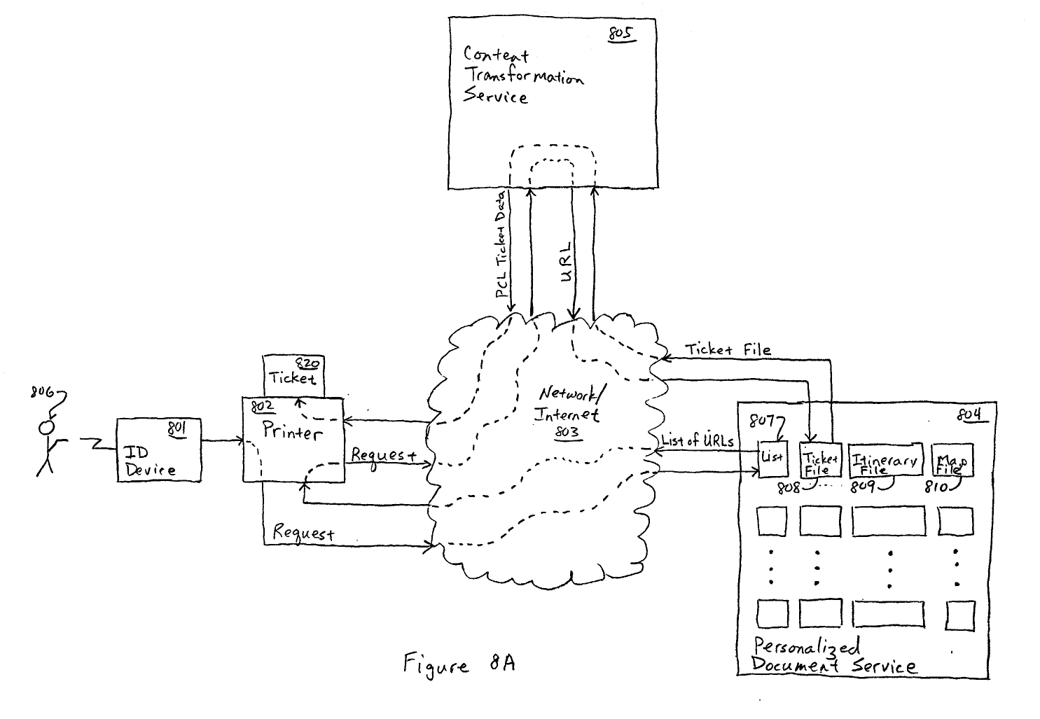

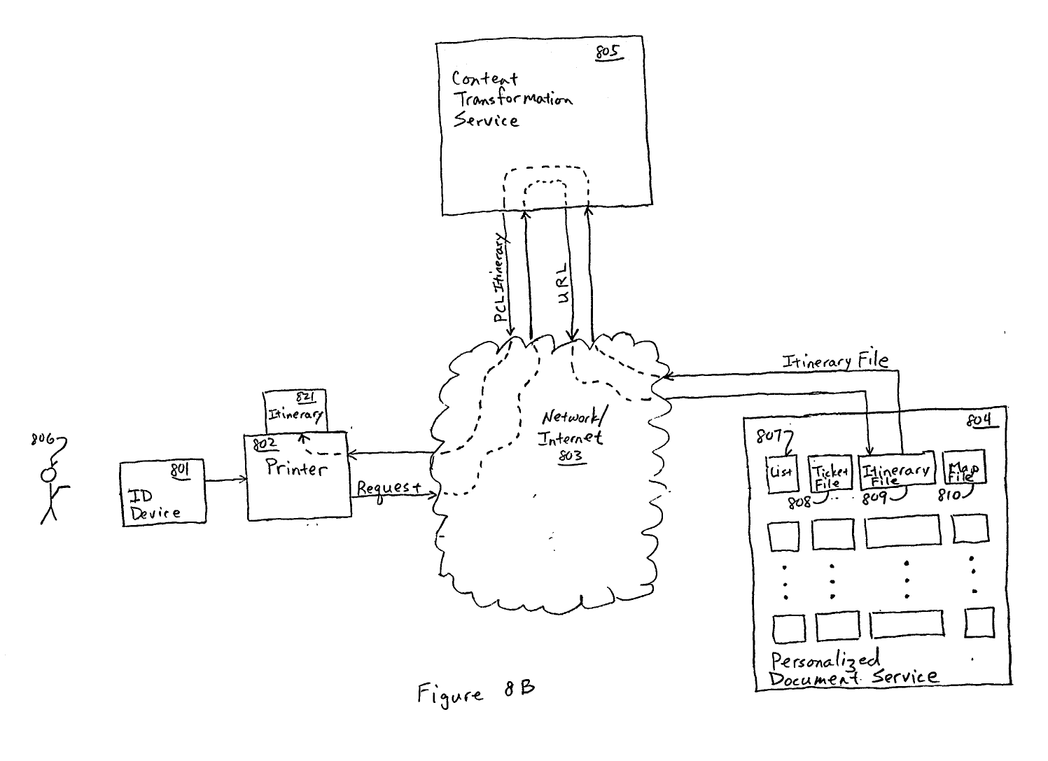

FIGS. 8A-C show an example of how a printer can be used to print personalized content in accordance with one embodiment of the present invention. Assume that a convention is being held. Printed information which may be relevant to attendees of the convention need to be furnished. Relevant information may include tickets, itineraries, and maps which are tailored to meet the particular dictates of each of the attendees. For example, one attendee might wish to attend a particular lecture whereas a different attendee might have no interest in that lecture. One attendee might wish to attend several presentations, whereas others might not want to pay for all the events. In some cases, there may be security, marketing, sales or other reasons for restricting or otherwise limiting access to a presentation. Consequently, each attendee may have their own ticket, itinerary, and map.

It would be of tremendous benefit if such tickets, itineraries, and maps could be efficiently, promptly, and reliably printed out on an as-needed basis with undue complexity and ease. This is made possible by using an ID tag to identify a particular attendee to a printer. An attendee simply provides his or her ID to one or more printers conveniently set up at various sites at the convention center. The printer recognizes the attendee and automatically finds and prints that person's ticket(s), itinerary, and map(s).

Prior to the date of the convention, the relevant information is entered into a server by an administrator. This function can be accomplished by a personalized document service 804. The personal document service 804 has files which include ticket, itinerary, and map information specific to each of the attendees. To print the relevant information retained by the personalized document service 804, an attendee provides a unique ID to an ID device 801. This can be accomplished by a smart card, badge, RF transmitter, or some other identification mechanism. Based on this unique ID, the printer 802 generates a URL which specifies the appropriate personal document service 804, the printer's context, and the ID. The printer's context in this example would be to print tickets, itineraries, and maps for this convention. Based on the URL, printer 802 transmits a request to personalized document service 804 over a network or the Internet 803. The personalized document service 804 transmits a list 807 of URLs which matches the given context and ID back over the network or Internet 803 to printer 802.

In this example, the personalized document service 804 would provide a list of three URLs for attendee 806 to printer 802. The first URL corresponds to ticket file 808. The second URL corresponds to itinerary file 809. And the third URL corresponds to map file 810. Each of these URLs are sequentially transmitted by printer 802 over the network/Internet 803 to a content transformation service 805 in the form of a request.

FIG. 8A shows how a request by printer 802 to content transformation service, eventually causes the attendee's ticket to be printed out. The request from printer 802 is sent over the network/Internet 803 to content transformation service 805. The request contains the first URL which points to the ticket file 808 in personalized document service 804. Activating the URL results in the ticket file 808 being transmitted over the network/Internet 803 to the content transformation service 805. Content transformation service 805 converts the ticket file into a printer-friendly format. The printer-friendly ticket data is then transmitted over the network/Internet 803 to printer 802. Upon receiving this data, printer 802 automatically prints out the ticket 820.

Next, the printer automatically prints out the itinerary without having the attendee re-enter his or her ID again. FIG. 8B shows how a request by printer 802 to content transformation service 805 results in the attendee's itinerary to be printed out. As described above, the personalized document service 804 provides a list of URLs in response to the initial request from printer 802. The second URL on the list points to the itinerary file 809 of personalized document service 804. A request from printer 802 is sent over the network/Internet 803 to content transformation service 805. The request contains the second URL which points to the itinerary file 809 in personalized document service 804. Activating the URL results in the itinerary file 809 being transmitted over the network/Internet 803 to the content transformation service 805. Content transformation service 805 converts the itinerary file into a printer-friendly format. The printer-friendly itinerary data is then transmitted over the network/Internet 803 to printer 802. Upon receiving this data, printer 802 automatically prints out the attendee's itinerary 821.

Next, the printer automatically prints out a map for the attendee. Again, this map is automatically printed. There is no need for the attendee to re-enter his or her ID. FIG. 8C shows how a request by printer 802 to content transformation service 805 results in the attendee's map to be printed out. As described above, the personalized document service 804 provides a list of URLs in response to the initial request from printer 802. The third URL on the list points to the map file 810 of personalized document service 804. A request from printer 802 is sent over the network/Internet 803 to content transformation service 805. The request contains the third URL which points to the map file 810 in personalized document service 804. Activating the URL results in the map file 810 being transmitted over the network/Internet 803 to the content transformation service 805. Content transformation service 805 converts the map file into a printer-friendly format. The printer-friendly map data is then transmitted over the network/Internet 803 to printer 802. Upon receiving this data, printer 802 automatically prints out the attendee's map 822.

The same set-up can be used by subsequent attendees to print out their respective tickets, itineraries, and maps. For example, another attendee may use the same or a different printer coupled to the network/Internet 803. As with the first attendee, the second attendee simply provides his or her ID to that printer. Based on the ID of the second attendee, the personalized document service 804 will return a list of URLs which correspond to the documents particular to that of the second attendee. For example, the second attendee's personal content may include his or her own ticket, itinerary, and map information. This information can be stored on the same server as that of the first attendee. Alternatively, the personal content may be stored on a different server belonging to a different web host or service. In addition, the personal content of the subsequent attendees may include other types of documents, such as lecture notes, a list of keynote speakers, white papers, slide shows, promotions, discount coupons, etc. There is no limit on the different types of documents, files, and personalized content and the context by which may be accessed and printed. Thereby, embodiments of the present invention provide a fast, economical, easy, flexible, and convenient way for people to print personalized content when they are away from their normal work or home environment.

Therefore, the preferred embodiment of the present invention, a method and apparatus for providing a user identification to a printer for printing personalized content, is thus described. While the present invention has been described in particular embodiments, it should be appreciated that the present invention should not be construed as limited by such embodiments, but rather construed according to the below claims.

What is claimed is:

1. A method for a printer to print personalized content stored on a network for a user, comprising:
detecting an identification which uniquely identifies the user;
determining a reference to the personalized content, wherein the reference is based upon the identification;
requesting the personalized content over the network according to the reference;
printing the personalized content, wherein the printer performs the detecting, determining, and requesting.

2. The method of claim 1 further comprising:
defining a context corresponding to the printer, wherein the context defines a task to which the printer is assigned.

3. The method of claim 1 further comprising:
processing a list of URLs which point to a plurality of documents which are to be printed based on the identification.

4. The method of claim 1 further comprising:
constructing a URL which identifies an electronic service, a context, and the identification.

5. The method of claim 1 further comprising:
transmitting a URL to a content transformation client;
accepting a printer formatted data from the content transformation client;
printing the printer formatted data which corresponds to the personalized content.

6. The method of claim 1 further comprising:
sending a request to a personalized document service;
returning the personalized content in response to the request.

7. The method of claim 1 further comprising:
transmitting the identification wirelessly.

8. A printer, comprising:
a first port for accepting a identification which uniquely identifies a user;
a processor coupled to the first port which generates a reference based on the identification, wherein the reference is used by the printer to retrieve personalized content from a network;
a second port coupled to the processor which interfaces the printer to the network, wherein a request for the personalized content is transmitted by the printer via the second port and the personalized content is received over the network by the printer through the second port.

9. The printer of claim 8, wherein the reference further comprises a context which defines a task to which the printer is assigned.

10. The printer of claim 8, wherein the processor processes a list of a plurality of URLs, each of the URLs specifying a document containing the personalized content which is to be printed by the printer.

11. The printer of claim 8, wherein the reference comprises a URL which identifies an electronic service, a context, and the identification.

12. The printer of claim 8, wherein the processor transmits a URL to a content transformation client over the network and accepts a printer formatted data from the content transformation client over the network.

13. The printer of claim 8, wherein the processor sends a request to a personalized document service and accepts the personalized content over the network in response to the request.

14. A client-server system, comprising:
a server coupled to a network, wherein personalized content corresponding to a user is stored on the server;
a client coupled to the network, wherein the client is a printer and the personalized content is retrieved from the server and printed out on the printer in response to an identification provided by the user.

15. The client-server system of claim 14, wherein a plurality of documents containing the personalized content is automatically printed out on the client printer in response to the identification provided once by the user.

16. The client-server system of claim 14, wherein a second user providing a second identification results in the printer printing a second document containing content personalized to the second user.

17. The client-server system of claim 16, wherein the second document is stored in a second server coupled to the network.

18. A printer, comprising:
an input port for accepting a user ID;
a worker process coupled to the port, wherein the process constructs a URL which identifies a personalized document service, a context, and the user ID;
a job queue coupled to the worker process, wherein a plurality of jobs corresponding to a plurality of users is temporarily stored pending execution;
a job processor coupled to the job queue which requests from a personalized document service a list of documents to be printed in accordance with the context and user ID of one of the jobs;
a content transformation client coupled to the job processor, wherein the client formulates and sends a request including a URL to a document to be printed, an IP address of the printer, and a port number to a content transformation service;
a network port for interfacing the printer to a network;
a printer processor coupled to the network port, wherein printer formatted data representing the document is received over the network is printed out on paper.

19. The printer of claim 18, wherein the user ID is provided by an RFID reader.

20. The printer of claim 18, wherein the user ID comprises biometrics data.

21. The printer of claim 18, wherein the user ID comprises a code manually entered by the user.

22. The printer of claim 18, wherein the user ID comprises a code stored on a magnetic media.

23. The printer of claim 18, wherein the user ID comprises a code that was scanned.

24. A personalized document service, comprising:
a memory for storing a plurality of documents containing personalized content corresponding to a plurality of users, wherein the documents are categorized according to user IDs;
an input coupled to the memory which accepts a request containing a particular user ID;
a processor coupled to the memory which references those documents corresponding to the particular user ID;
an output coupled to the processor which transmits the documents over a network.

25. The personalized document service of claim 24, wherein the processor outputs a list of references corresponding to the documents containing personalized content belonging to a received user ID, the list being transmitted over the network to a printer.

26. The personalized document service of claim 24, wherein the processor outputs one of the documents to a content transformation service in response to a provided reference.

27. The personalized document service of claim 26, wherein the reference comprises a URL.

28. A content transformation service, comprising:
an input coupled to a network for accepting a reference from a printer, wherein the reference corresponds to a user ID;
an output coupled to the network for transmitting the reference over the network to request a document containing personalized content corresponding to the user ID;
a processor coupled to the input which transforms the personalized content received by the input into a printer compatible formatted data which is then transmitted by the output over the network to be printed by a printer.

29. The content transformation service of claim 28, wherein the printer comprises a client printer.

30. The content transformation service of claim 29, wherein the user ID is provided to the client printer.
